(19) United States
(12) Patent Application Publication
(10) Pub. No.: US 2010/0205951 A1
(43) Pub. Date: Aug. 19, 2010

(54) Hydrostatic differential transmission

(76) Inventor: Richard E. Leker, Pelican Rapids, MN (US)

Correspondence Address: THOMTE LAW OFFICE, L.L.C., 2120 S. 72ND STREET, SUITE 1111, OMAHA, NE, 68124, US

(21) Appl. No.: 12/378,302

(22) Filed: Feb. 13, 2009

(51) Int. Cl. F16H 61/42

(52) U.S. Cl. 60/445; 60/428

(57) ABSTRACT

A hydrostatic differential transmission comprising a cylinder housing containing an input pump and an output pump. The two hydraulic pumps are mounted with the output pump inside the input pump. The input pump has an adjustable swash plate. The output pump has a fixed swash plate. The pistons of the input and output pumps share inter-connected piston bore housings. An adjustable control selectively pivots the adjustable swash plate between a neutral position, where the swash plate is at a 90 degree angle to the input shaft and maximum tilt of the swash plate for a one-to-one ratio of the input shaft and output shaft.

### BACKGROUND OF THE INVENTION

1. Field of the Invention

This invention relates to a hydraulic transmission and more particularly to an improved hydraulic differential transmission. More particularly, the transmission is comprised of a housing which contains both an input pump and an output pump which share connected cylinder bores for the pistons thereof. Even more particularly, the present invention relates to a transmission with an input pump and an output pump which is mounted one inside the other. The cylinder bore units of each pump are connected with spines or lugs so that they operate as a unit but still serve each pump independently.

2. Description of the Related Art

Hydraulic transmissions are used in a wide variety of vehicles and other equipment to change the ratio of the input shaft speed relative to output shaft speed. Conventionally, a hydraulic pump unit with a cooperating swash plate on the input side of the transmission interact to displace hydraulic fluid to an outside pump which in turn connects with an outside swash plate in a manner to rotate the output shaft. The transmission ratio essentially depends on the fluid displacement ratio of the two pumps.

In standard hydraulic pumps, a greater flow of hydraulic fluid creates a greater output transmission shaft rotation. Thus, as the rotation of input shaft speed approaches one-to-one the output shaft speed, the oil flow is the greatest. However, this condition results in the utilization of movement of many parts resulting in wear of the various components during the highest output of the drive.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

The hydrostatic differential transmission of this invention consists of two hydraulic pumps with one pump mounted inside the other pump. The piston bore housing of each pump are connected with spines or lugs so that they work together and serve as a differential which transmits the power from the input pump to the output pump. The bases of both pumps serve as valve plates to control the flow of fluid through the fluid passageways. The base of the output pump has two grooves, one for high pressure fluid and one for low pressure fluid, located in the machined surface, which in a parallel plane to the output shaft. The machine surface of the output pump base matches the machined surface of the input pump to control the flow of fluids between the pumps. The hydraulic pumps of this invention are rotationally mounted for rotation on coaxially aligned input and output shafts respectively. The input pump has an adjustable swash plate which when tilted from its neutral position provides a compression stroke that pushes the fluid to the output pump where the fluid expands the pistons and pushes the fixed swash plate. The low pressure side of the output pump pushes the fluid through the fluid passage, to the low pressure side of the input pump.

When the input pump adjustable swash plate is tilted 90° (FIG. 2) from the input shaft, the transmission is in a neutral position and will not pump any fluid. When the adjustable swash plate is adjusted from the neutral position away from perpendicular, a varying degree of power of speed is provided. When the adjustable swash plate is tilted to the same angle as the fixed swash plate (FIG. 1), there is no flow of fluid if both the input pump and the output pump are being rotated at the same speed in a one-to-one ratio. An adjustable control selectively pivots the adjustable swash plate to control the ratio of the rotational speed of the input shaft with respect to the output shaft.

It is therefore a principal object of the invention to provide an improved hydrostatic transmission in which the transmission ratio is infinitely variable between a neutral condition and a direct drive condition.

A further object of the invention is to provide a hydrostatic transmission including a differential unit which controls the ratio of the power transmitted between the input and output pumps.

Still another object of the invention is to provide a hydrostatic transmission in which the greatest power output occurs in the one-to-one position when no oil is being pumped and no parts are moving.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a longitudinal sectional view taken centrally through the hydrostatic differential transmission according to a preferred embodiment of the transmission in a direct drive or a one-to-one ratio setting;

FIG. 2 is a sectional view similar to FIG. 1 but which illustrates the variable swash plate rotated to its 90° position wherein the transmission is in a neutral drive condition or setting; and

FIG. 3 is a plan view of the faces of the valve surfaces with ports and fluid passages formed therein.

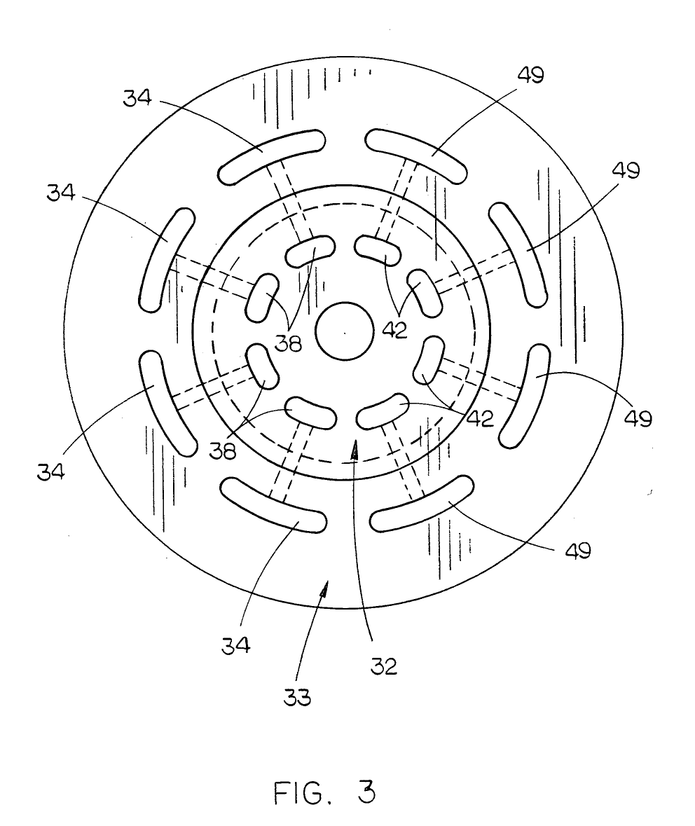

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

Transmission 10 includes a housing 11 which is constructed according to a preferred embodiment of the invention. Transmission 10 transfers power in a variable ratio from an input shaft 12 to an output shaft 14, which is axially aligned therewith. In a normal application, input shaft 12 is rotated by a drive motor, engine or other power source (not shown).

Transmission 10 includes an input pump 16 which is positioned in the housing 11, and includes input shaft 16, adjustable swash plate 18, and cylinder bore housing 20 with pistons 22 and 24. the output pump 26 includes a fixed swash plate 28 and output shaft 14 which is attached by splines 30 to the base 32, and the cylinder bore housing 21 having the pistons 22A and 24A mounted therein.

The transmission fluid flows from the high pressure side of the input pump 16 to the high pressure side of the output pump 26 through passageways 34, 36 and 38. The low pressure side (replacement fluid to the pumps) causes flow from the output pump 26 to the low pressure side of the input pump 16 through passageways 40, 42 and 49.

The base valve plate 32 of the transmission has the groove or passageway 40 formed therein around the perimeter thereof to permit the flow of transmission fluid from the low pressure side of the output pump 26 to the low pressure side of the input pump 16 through passageways 42 and 44. The base valve plate 32 has the groove or passageway 36 formed therein around the perimeter of the plate 32 to permit the flow of transmission fluid from the high pressure side of the input pump 16 to the high pressure side of the output pump 26 through passageways 34 and 38. the grooves are necessary to permit flow of fluid as the input and output pumps rotate independently of one another.

A machined surface on the bases of input and output pumps, parallel to the output pump shaft, serves to control the fluids in grooves and passages between the input and output pumps.

Friction pads 46, 48, 50 and 52 are mounted on the ends of pistons 22, 24, 22A and 24A respectively for contact with the adjustable swash plate 18 and fixed swash plate 28.

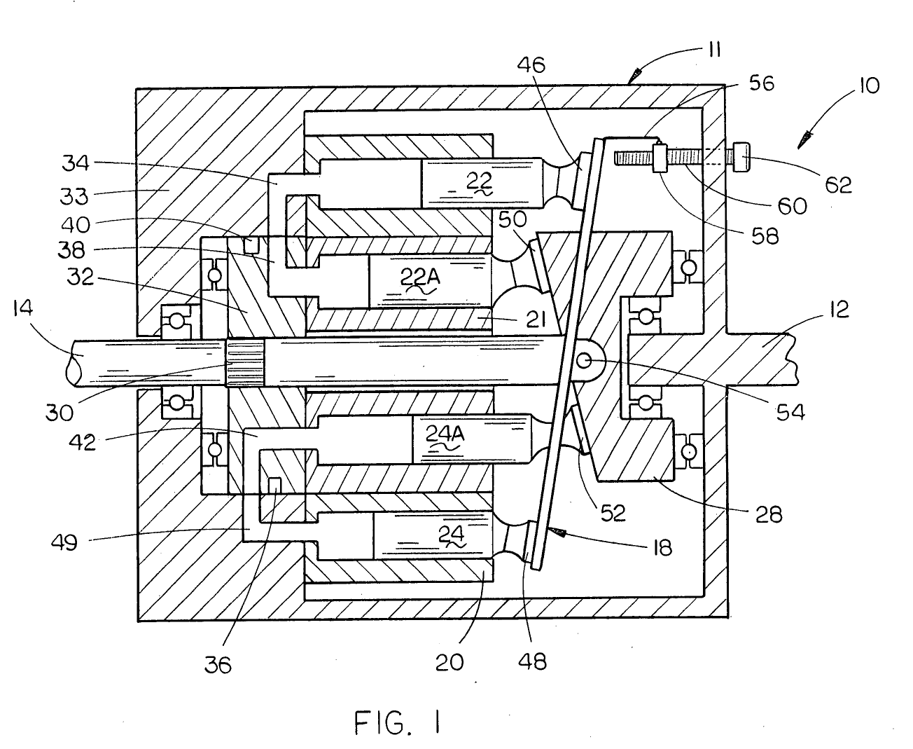

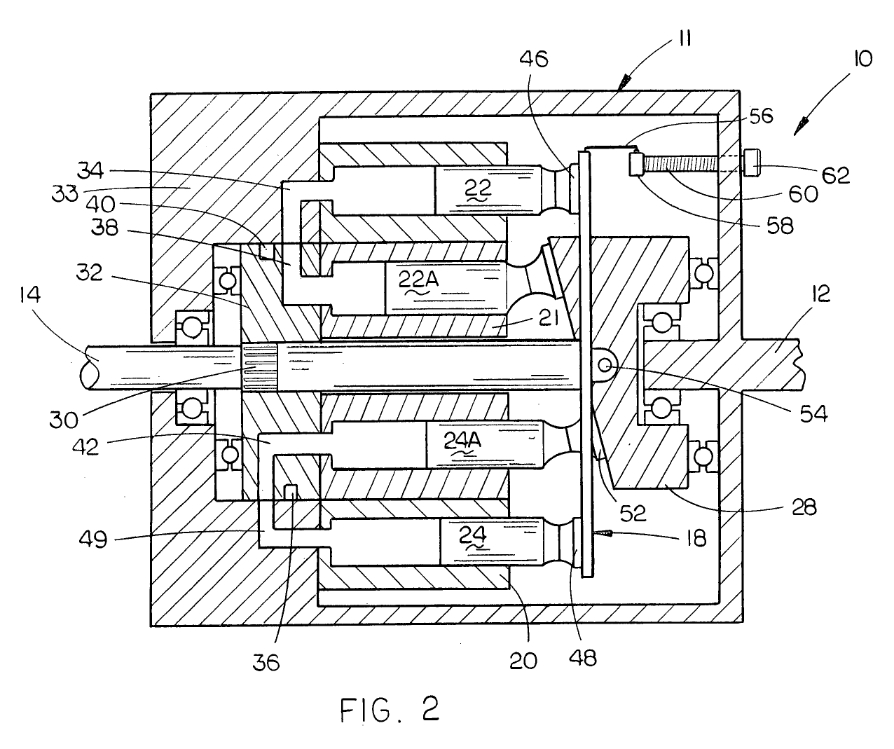

Adjustable swash plate 18 is pivotally movable with respect to housing 11 by the pivot pin 54. Adjustable swash plate 18 is pivoted with respect to the housing 11 by a link 56 connecting one edge of plate 18 to a threaded adjustment nut 58 mounted on threaded shaft 60. As the adjustable swash plate is moved between the direct drive position of FIG. 1 and the neutral position of FIG. 2, the speed of rotation of the differential units on 20 and 21 will vary, thereby changing the ratio of rotation of input shaft 12 with respect to the output shaft 14. The adjustment of the swash plate 18 occurs by rotation of shaft head 62 by a power source which is not shown.

The transfer of transmission fluid between the input pump 16 and outlet pump 26 is determined by the tilt of the adjustable swash plate 18. The varying tilt from perpendicular to the maximum tilt of the adjustable swash plate 18 on the input pump 16 will change the rate of flow of liquid from the input pump 16 to the output pump 26. Both the input and output pumps have the same maximum displacement, resulting in both the input and outlet pumps rotating at the same speed. When both pumps are rotating at the same speed, there will be no flow of fluid between the pumps thereby resulting in a one-to-one or direct drive situation.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. A hydrostatic differential transmission, comprising:
a hollow, cylindrical housing containing both an input hydrostatic pump and an output hydrostatic pump with the input pump surrounding the output pump.

2. The transmission of claim 1, further including a control means which includes means for pivoting an adjustable swash plate to a plurality of positions between neutral and direct-drive positions.

3. An inter-connected housing of the bores of the pistons of an input pump and an output pump which serves individually both the input pump and output pump and work together serving as a differential to control the speed between the input and output pumps so that the hydrostatic transmission proceeds from a neutral mode to a direct drive mode, the speed of the inter-connected bore housing or differential will vary.

4. A hydrostatic differential transmission comprising:
an input shaft attached to an adjustable swash plate of an input hydraulic pump presenting a plurality of bores with a piston disposed for reciprocating movement in each bore to displace hydraulic fluid therein;
an output hydraulic pump comprising an output shaft attached to a fixed swash plate presenting a plurality of bores each of which receives a piston for reciprocating movement;
said input pump and output pump being arranged in a substantially closed hydraulic circuit whereby fluid displaced in each pump is directed to the other pump;
when both pump's swash plates are tilted to the same degree for pumping at maximum displacement, both the input and output pumps will rotate at the same speed;
when rotating at the same speed there will be no flow between the input and output pumps and result in a one-to-one or direct-drive situation, thereby resulting in no moving parts in the transmission.
a machined surface on the bases of the input pump and output pumps parallel to the output pump shaft, which serves to control the flow of fluid between the input and output pumps.

5. The transmission of claim 4 further including a machined surface on the bases of said input pump and output pumps which are parallel to the output pump shaft, which serve to control the flow of fluid between the input and output pumps.
